(19) United States
(12) Patent Application Publication
(10) Pub. No.: US 2023/0289858 A1
(43) Pub. Date: Sep. 14, 2023

(54) A METHOD FOR MONITORING A PROJECT

(71) Applicant: IBUILDPRO HOLDINGS LIMITED, London (GB)

(72) Inventors: Keano CHANG, London (GB); Allar AHTMANN, London (GB)

(73) Assignee: IBUILDPRO HOLDINGS LIMITED, London (GB)

(21) Appl. No.: 18/008,125

(22) PCT Filed: May 27, 2021
(86) PCT No.: PCT/GB2021/051306

§ 371 Date: Dec. 2, 2022

(30) Foreign Application Priority Data
Jun. 4, 2020 (GB) 2008411.7

(51) Int. Cl. G06Q 30/0601; G06Q 10/10

(52) U.S. Cl. CPC G06Q 30/0609; G06Q 30/0611; G06Q 10/103; G06Q 50/163

(57) ABSTRACT

The present invention relates to a computer implemented method for monitoring the initiation, progression and completion of a project, the computer implemented method comprising the method steps of: allowing a customer to create a project profile; associating a service provider with the project profile; providing a project pathway comprising at least one project milestone; associating the project pathway with the project profile; recording the project pathway and the project profile on a central resource; recording the completion of the at least one project milestone on the central resource; and cross-checking the completion of the at least one project milestone with a reference source.

### FIELD OF THE INVENTION

The present invention relates to a computer implemented method for monitoring the initiation, progression and completion of a project. The present invention further relates to a data processing apparatus for carrying out the computer implemented method. The present invention also relates to a computer program for causing a computer to carry out the computer implemented method. The present invention further relates to a computer-readable medium for causing a computer to carry out the computer implemented method.

### BACKGROUND TO THE INVENTION

Projects require two-way trust to be built between the provider of the service who is undertaking the project and the receiver of the service who initiates the project. Often there is high risk to both parties associated with the project, be that in financial, time, material, reputational, legal, security or safety risks. As such, it is important that the service provider and the customer are able to monitor the progress of a project from initiation to completion, such that meaningful trust may be built between both parties.

There are many benefits to the service provider in accurately monitoring the progress of the project, such as ensuring the project is on track for timely completion, is within budget, and the completed project matches the promised deliverables. However, often it is challenging for the customer to also view and monitor the progression of the project. Additionally, there are challenges upon project completion if either party fails to deliver what is expected from them, or if the deliverables set at the start of the project were not clearly defined.

Further, the nature of many projects means that delays, obstacles and complications are commonplace. The benefit of allowing both parties to monitor project progression assists in managing expectations and allows adjustments to the project to be made throughout the project duration.

In this way, there is a need for a means for both the service provider and the customer to initiate and monitor projects through to completion, such that trust can be built and risk to both parties is lowered.

Embodiments and aspects of the present invention seek to address at least the above problems of the prior art.

### SUMMARY OF THE INVENTION

According to a first aspect of the present invention there is provided a computer implemented method for monitoring the initiation, progression and completion of a project, the computer implemented method comprising the method steps of: allowing a customer to create a project profile; associating a service provider with the project profile; providing a project pathway comprising at least one project milestone; associating the project pathway with the project profile; recording the project pathway and the project profile on a central resource; recording the completion of the at least one project milestone on the central resource; and cross-checking the completion of the at least one project milestone with a reference source.

In this way there is advantageously provided a method for reliable recording and monitoring a project's progress to a central resource. Such a resource is of great advantage to not only the service provider but also the customer and any third party associated with the project. Verified data regarding the project progress is recorded, building trust between the customer and service provider as well as providing an early indication of future issues that may be encountered. Accurate monitoring of project progress allows action to be taken by any party involved ensuring future problems or issues are minimised and risk to all parties is lowered. Such a resource is also advantageous in improving the reputation and credibility of each party involved in the project.

Preferably, the step of allowing a customer to create a project profile comprises the steps of: allowing the customer to provide verifiable project data; and cross-checking at least one item of verifiable project data against the reference source. In this way, project data provided by the customer is verified such that a reliable, truthful data profile is built and trust can be built between the customer and the service provider.

Preferably, the step of associating a service provider with the project profile comprises the steps of; allowing a plurality of service providers to express interest in becoming associated with the project profile by providing bid data; recording the bid data to the central resource; allowing the customer to view the bid data recorded to the central resource; and allowing the customer to choose which service provider becomes associated with the project profile. This benefits both the customer and the service provider, as the customer may make a more informed choice before the project is initiated by selecting the best fit from a plurality of service providers. Preferably, the method further comprises cross checking the bid data with the reference source. In this way, historic bid data can be used to cross check whether bids are at an appropriate level.

Preferably, the step of providing a project pathway comprising at least one project milestone comprises retrieving an interim project pathway from the central resource. More preferably, the step of providing the project pathway further comprises allowing the customer and or the service provider to adjust the interim project pathway. In this way, standardised data regarding average or similar pathways to the interim project pathway is associated with the interim project pathway for adjustment and personalisation by the customer and or the service provider.

Preferably, the project pathway is agreed by both the customer and the service provider, and the agreement of both the customer and the service provider is recorded to the central resource. In this way, the deliverables of the project are agreed prior to initiation of the project, such as an appropriate timeframe for completion, and expectations of the customer and service provider are managed. Additionally, work on the project will not commence until both parties involved with the project have reached an agreement and are satisfied.

Preferably, the method comprises prompting the service provider and or the customer to complete the at least one project milestone within the project pathway. Preferably, the method further comprises issuing an alert if the at least one project milestone is not completed within at least one predetermined time period. Preferably, the at least one predetermined time period is retrieved from the central resource. More preferably, the project pathway comprises the at least one predetermined time period.

Preferably, the method further comprises the steps of; identifying at least one incomplete project milestone within the project pathway; and communicating the project milestone and its status to at least one of the customer, the service provider and or a third party. In this way, achievement or failure to reach milestones is communicated to any relevant party prior to completion of the project.

Preferably, the method comprises the steps of allowing the customer and or the service provider to mark the or the at least one project milestone within the project pathway as complete, and recording the completion of the at least one project milestone in the central resource. Preferably, the method further comprises cross checking the completion of the at least one project milestone with the reference source; and recording data associated with the result of the cross check to the central resource. Preferably, the method further comprises recording data associated with the completion of the at least one project milestone to the central resource. Preferably, the method further comprises cross checking the data associated with the completion of the at least one project milestone with the reference source; and recording data associated with the result of the cross check to the central resource. Preferably, the method further comprises the steps of; retrieving a list of project milestones associated with the project pathway from the central resource; retrieving a list of competed project milestones from the central resource; comparing the two lists; and recording the completion of the project pathway in the central resource if the tasks associated with the project pathway have been completed.

Preferably, the reference source comprises a third-party database. Alternatively or additionally, the reference source comprises the central resource. Alternatively or additionally, the reference source comprises information provided by the customer, the service provider or a quality controller.

Preferably, the method further comprises recording the association of the customer, the service provider and the project pathway in the central resource.

According to a second aspect of the present invention there is provided a data processing apparatus comprising means for carrying out the method according to the first aspect of the invention.

According to a third aspect of the present invention there is provided a computer program comprising instructions which, when the program is executed by a computer, cause the computer to carry out the method according to the first aspect of the present invention.

According to a fourth aspect of the present invention there is provided a computer-readable medium comprising instructions which, when executed by a computer, cause the computer to carry out the method of the first aspect of the present invention.

### DETAILED DESCRIPTION

Embodiments of the present invention will now be described by way of example and with reference to the accompanying drawings, in which:

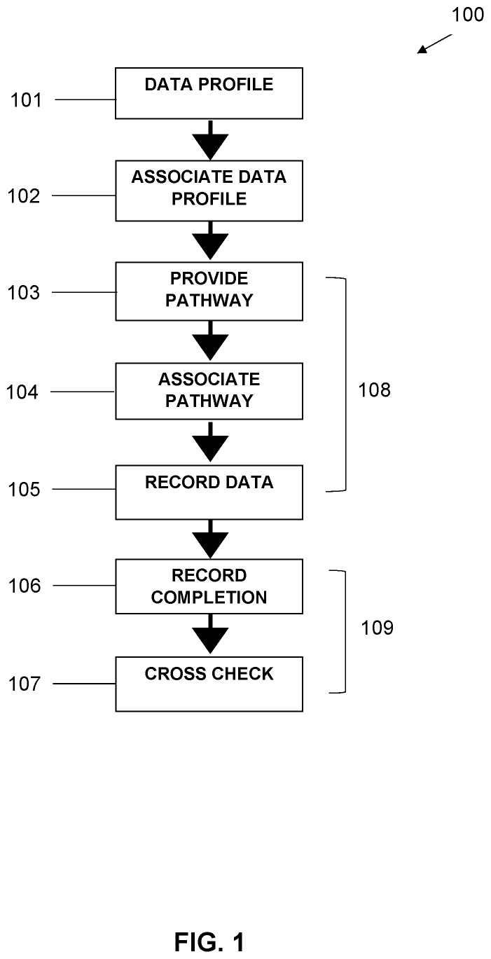

FIG. 1 is a schematic view of a computer implemented method according to the first aspect of the present invention;

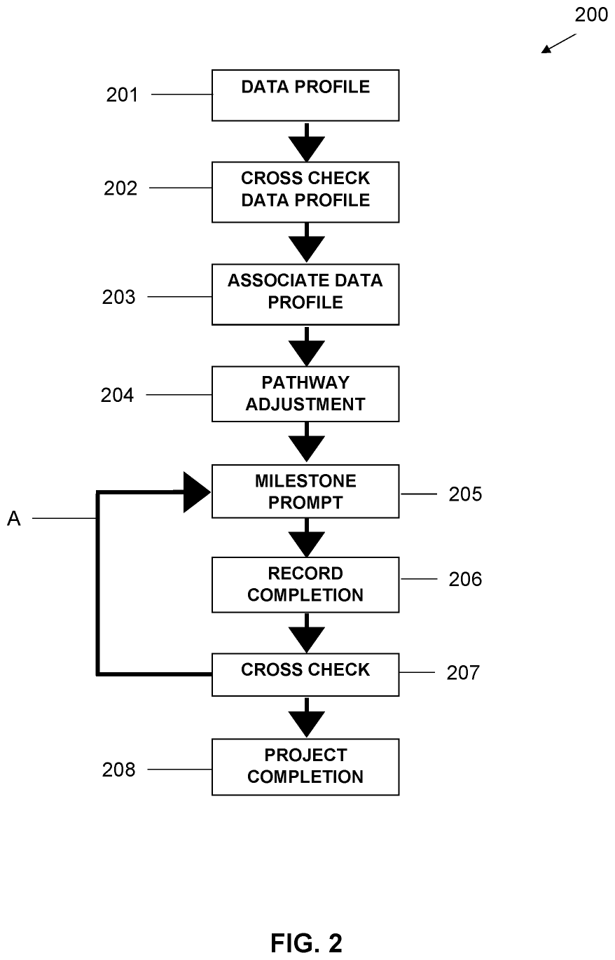

FIG. 2 is a schematic view of a second embodiment of the computer implemented method of FIG. 1, according to the first aspect of the present invention;

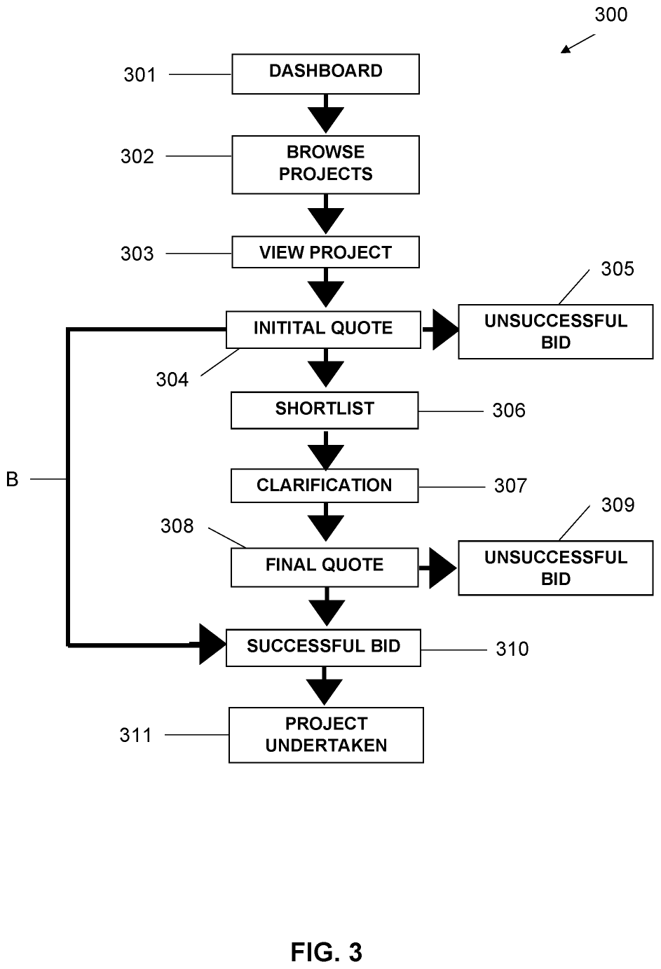

FIG. 3 is a schematic view of a third embodiment of the computer implemented invention of FIG. 1, according to the first aspect of the present invention; and

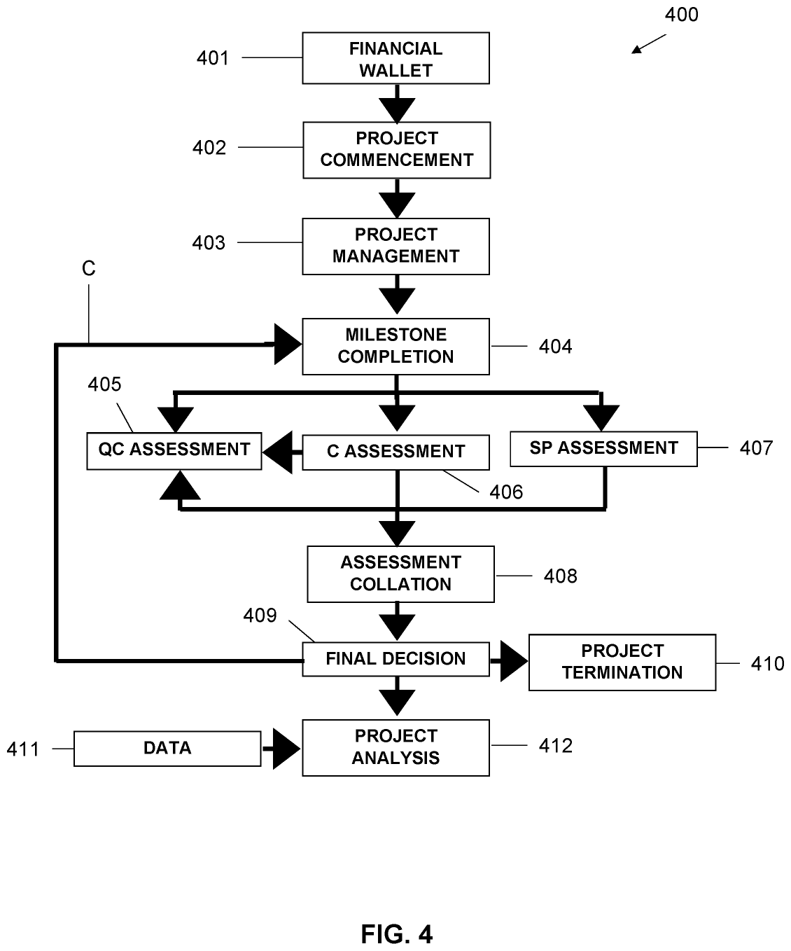

FIG. 4 is a schematic view of a fourth embodiment of the computer implemented method of FIG. 1, according to the first aspect of the present invention.

Herein, the method is described in relation to building, construction, renovation and remodelling projects, but it is envisaged that the method and related technology can be applied to any project wherein a service provider is providing a service on a project initiated by a customer. It is understood that a service provider may be any suitable individual, company or organisation providing a service, such as a construction company, a kitchen manufacturer or an electrician. It is understood that a customer may be any suitable individual, company or organisation initiating a project.

Referring firstly to FIG. 1, there is shown schematic view of a computer implemented method 100, according to the first aspect of the invention. The method 100 allows a customer to create a project profile associated with a service provider, such that data regarding the progress and completion of project milestones can be cross checked and recorded, allowing project initiation, progression and completion to be monitored. This allows a central resource of verified data to be built such that accurate information regarding the project progress can be recorded and monitored.

The first step of the method 100 is a DATA PROFILE step 101. Herein, the customer is allowed to create a project profile containing data regarding a project. For example, the customer may be a homeowner and the project is painting the external walls of the customer's property. The customer provides data in the project profile such as the information regarding the customer, the postcode, area or address of the property, number of stories, required finish, property age, deadline for project completion, project budget and any specific project requirements, such as the project may only be undertaken on weekends. The data contained in the project profile may additionally or alternatively be provided in the form of documentation, such as ID or proof of property ownership, hyperlinks to websites and images, such as an image of the property exterior.

The next step of the method 100 is an ASSOCIATE DATA PROFILE step 102, wherein the project profile is associated with a service provider. In this example, the service provider is a professional painter who will undertake the project.

Following this, a PROVIDE PATHWAY step 103 comprises providing a project pathway comprising at least one project milestone. The project pathway in this example comprises two project milestones; preparing the property exterior for painting, and painting the property exterior. In order to complete the first project milestone, the service provider must prepare the property for painting, such as by cleaning, sanding or repairing damage to the exterior walls to improve paint application. In order to complete the second project milestone, the service provider must paint the property exterior.

Next, the project pathway is associated with the project profile in an ASSOCIATE PATHWAY step 104. Following this, both the project pathway and the project profile are recorded on a central resource, such as a central database or central ledger, in a RECORD DATA step 105. In this way, all data regarding the project is stored in a central location.

The PROVIDE PATHWAY step 103, ASSOCIATE PATHWAY step 104 and RECORD DATA step 105 comprise a PATHWAY stage 108.

There follows a RECORD COMPLETION step 106 wherein either the customer or the service provider records completion of each project milestone, in turn, on the central resource. In this way, milestones that are associated with either the customer or the service provider, or require input from both parties can be marked as complete by the appropriate party.

In this example, the RECORD COMPLETION step 106 comprises the service provider recording each project milestone as complete and providing evidence of milestone completion, for example, in the form of a media file, official documentation, a third party statement or proof of receipt, uploaded to the central resource. This allows the service provider, customer or a third party to externally view the progress of the project in relation to the key project milestones.

The benefit of storing all data regarding the project on a central resource is that all parties can view the progression of the project. This is of particular benefit wherein the customer is external to the project site, or for employers who would like to monitor the work of an employee, such as an apprentice. Additionally, on projects wherein the customer comprises a plurality of customers or there are third party stakeholders, all parties can monitor the initiation, progression and completion of the project remotely.

There follows a CROSS CHECK step 107, wherein the completion of each milestone is cross checked with a reference source. In this example, the service provider's recorded completion of the project milestone is cross checked with the media file uploaded by the service provider to the central resource. If the evidence provided by the service provider satisfies the recorded completion of the milestone, this milestone is marked as complete.

The benefit of cross checking and confirming the completion of each project milestone is that a profile of factual, accurate information regarding the project can be built, improving reliability and confidence in the service provided by the service provider. Further, the time of completion of each milestone can be monitored by all parties, such that delays and setbacks are quantified and identified in real time. There is also provided periodic project review points wherein the customer or service provider may raise concerns, queries or feedback regarding the progression of the project. Feedback is requested and provided in the form of an automatically generated feedback form, the data returned therein is recorded to the central resource. It is envisaged that the periodic project review points occur continuously throughout the project duration. Alternatively or additionally, the customer and or service provider is prompted to provide feedback upon completion of every milestone. In this way, the association of the project pathway with at least one project milestone assists both parties in raising concerns or resolving disputes at the time they occur.

The RECORD COMPLETION step 106 and CROSS CHECK step 107 comprise a CROSS CHECK stage 109.

With reference to FIG. 2, there is provided a schematic view of a further embodiment of the computer implemented method according to the first aspect of the present invention. The method 200 comprises the stages undertaken such that a project's progress can be monitored. The method 200 stages are carried out on a computer via customer and service provider access to a software and or website platform. It is envisaged that the method 200 stages may be undertaken in an alternative order to that presented in the embodiment.

The method 200 comprises a PATHWAY PHASE 108 and at least one MILESTONE CROSS CHECK phase 109 in accordance with the embodiment of FIG. 1. In this example, the customer is a business, the project is the renovation of the office building owned by the business and the service provider is a renovation company. The method 200 allows members of the business and members of the renovation company to remotely monitor the project initiation, progress and completion.

The first stage of the method 201 is a DATA PROFILE step 201, wherein the customer is allowed to create a project profile comprising verifiable project data regarding the office renovation project in accordance with the DATA PROFILE step 101 of FIG. 1. Herein, the customer provides proof of ownership of the office building as well as proof of funds required to complete the project.

Next, the verifiable project data provided in the DATA PROFILE step 201 is cross checked against a reference source in a CROSS CHECK DATA PROFILE step 202. Herein, customer ownership of the building is verified by cross checking the provided proof of ownership, be that through direct contact with the leaser or by cross referencing with a third party official database of records. Where possible, each item of verifiable data is cross checked with a plurality of reference sources to improve reliability and credibility of the provided data. A benefit of cross checking the verifiable data is that the service provider has confidence that initiation of the project is valid and legal and the costs of undertaking the project can be met by the customer. This builds service provider trust in the customer, increases likelihood of successful project completion, reducing risk to all parties involved in the project.

There follows an ASSOCIATE DATA PROFILE step 203 in accordance with the ASSOCIATE DATA PROFILE step 102 of FIG. 1. Herein, the service provider accepts the undertaking of the project and is associated with the project profile.

Next, a PATHWAY ADJUSTMENT step 204 comprising a PATHWAY phase 108 is initiated. Herein, the step of providing a project pathway comprising at least one project milestone further comprises retrieving an interim project pathway from the central resource and allowing both the customer and the service provider to adjust this interim project pathway. In this way, a project pathway with standardised characteristics and project milestones based on average or similar project pathways undertaken previously is provided, such that the project pathway and project milestones can be further personalised to the project.

For example, the customer may adjust the project pathway to reflect their renovation project's desired timeline, budget and other characteristics. The service provider then reviews the adjusted project pathway and submits their own adjustments or raises queries with the customer. There begins a dialogue between the customer and the service provider such that an agreement as to the scope of the project is reached and the project pathway is adjusted to satisfy all parties. The agreement of both the customer and the service provider is recorded on the central resource. The central resource aids in preventing and resolving future disputes between the customer and the service provider, as important project characteristics, such as the timeline for completion, are well defined and recorded on the central resource prior to the service provider beginning work on the project.

Additionally, if no project pathway that satisfies all parties can be created, the service provider may walk away from the project or the customer may dismiss the service provider without prejudice. In this way, ill matched project and service provider relationships are ceased without legal, financial or reputational risk or cost to either party.

The PATHWAY ADJUSTMENT step 204 further comprises the step of recording the association between the customer, service provider and project pathway on the central resource. In this way, the central resource comprises all data regarding the adjusted project pathway. The data on the central resource can then be usefully applied to aid in future project pathways undertaken by the customer and the service provider. For example, this data can act as evidence to prove a service provider's competence in completing a type of project; the data can inform and adapt interim pathways retrieved from the central resource; and the association between a customer and a service provider is remembered when future projects are undertaken together.

Next, a MILESTONE PROMPT step 205 is initiated. Herein, the party or parties who will complete the first project milestone are prompted to do so. For example, the customer may be prompted to return signed documentation and keys to the property to the service provider, or the service provider may be prompted to complete the first renovation task, such as install scaffolding at the property.

If the project milestone is not completed within a predetermined time period, an alert is issued that the milestone is incomplete. The predetermined time period is retrieved from the central resource, wherein the adjusted project pathway comprises the predetermined time period approved by both parties in the PATHWAY ADJUSTMENT step 204.

The MILESTONE PROMPT step 205 further comprises identifying that the project milestone is incomplete and communicating the status of the project milestone to the customer and the service provider. In this way, there is motivation for each party to complete each task and project milestone within the predetermined time period, as incomplete work is flagged up to the other party in real time. This improves accountability of both parties, and real time notification of delays improves response times in tackling the cause of a delay. Further, if one party is repeatedly failing to meet project milestones, the other party is notified and may choose to terminate the project before further cost and risk is accumulated.

There follows, a RECORD COMPLETION step 206, in accordance with the RECORD COMPLETION step 106 of FIG. 1, wherein the customer and the service provider are allowed to mark each project milestone as complete, with the completion of each project milestone recorded in the central resource. This creates a central resource with up-to-date data regarding the progress of the project. The completion of each project milestone and task is communicated to each party, such that all parties associated with the project are notified of the project's progress. Further, this encourages completion earlier than the end of the predetermined time period, such that customer-service provider satisfaction and trust increases.

Upon a milestone being recorded as complete in the RECORD COMPLETION step 206, a CROSS CHECK step 207 is initiated in accordance with the CROSS CHECK step 107 of FIG. 1. Herein, the completion of each project milestone is cross checked with the reference source and the data associated with the result of the cross check is recorded to the central resource. In this way, a list of verified, completed project milestones is built in the central resource.

The reference source may comprise information provided by a customer, service provider or quality controller. A quality controller may be a specific party authorised to assess the quality of any given work or service. Alternatively, quality controller may be interpreted as any third party that verifies the quality of work or service, preferably based on selected criteria. For example, a quality controller may be a building surveyor or certified tradesman issuing a completion certificate approving the safety and quality of renovation work completed. Alternatively, the service provider may upload a media file showing the completion of a milestone in the RECORD COMPLETION step 206 to the central resource. The customer may then review this evidence and record their approval of the work completed to the reference source. In this way, the reference source may comprise the central resource.

For example, the customer may confirm that they have received planning permission from the local authorities by marking the planning permission milestone as complete. However, a cross check with a third-party database from the local authority may show that planning permission has not been granted and this milestone is incomplete. The MILESTONE PROMPT step 205 is then reinitiated (arrow A), such that the customer is prompted to undertake this milestone again. In this way, dishonest or false completion claims are recorded, such that they can be viewed by all parties involved in the project, and further progress on the project cannot be undertaken until each milestone has been completed.

This also allows both parties to manipulate and rearrange the project milestones in the project pathway. Upon agreement of both parties, the order of the project milestones can be amended such that any delays in completion of a project milestone have a reduced impact on the deadline for completion of the project. For example, if there is a delivery issue and there is a delay in receiving the materials required to undertake the project milestone, an alternative project milestone may be initiated (arrow A) in a MILESTONE PROMPT step 205. In this way, the service provider or customer can work towards an alternative milestone, if appropriate, and return to the delayed milestone when the materials are delivered, such that progress on the project may continue.

When the completion of a project milestone has been successfully cross checked and verified, the MILESTONE PROMPT step 205 is reinitiated (arrow A) for the proceeding milestone. This iteration is repeated, such that the list of verified, completed project milestones is built upon in the central resource.

The CROSS CHECK step 207 further comprises retrieving the list of project milestones associated with the project pathway and retrieving the list of verified, completed project milestones recorded in the central resource and comparing the two lists. When all project milestones and tasks associated with the project pathway are completed, the completion of the project pathway is recorded in the central resource.

When completion of the project pathway is recorded to the central resource, a PROJECT COMPLETION step 208 is initiated. Herein, all parties are notified of project completion. Post project completion steps may then be undertaken by both parties, such as a final customer or quality controller evaluation of work completed, payment for services and analysis of project success and future areas for improvement.

With reference to FIG. 3, there is provided a schematic view of a further embodiment of the computer implemented method according to the first aspect of the present invention. The method 300 comprises the steps undertaken by a service provider to commence work on a project initiated by a customer. The central resource comprises a list of a plurality of customer projects where the customer is seeking a service provider to undertake the project.

The method 300 begins with a DASHBOARD step 301. Herein, the service provider may create, or access from the central resource, a service provider profile comprising data regarding the service provider, including contact details, location, area of trade or business and capacity or availability.

There follows a BROWSE PROJECTS step 302, wherein the service provider may browse a project list of available projects on the central resource. The projects on the project list are collated using the service provider data of the DASHBOARD step 301. In this way, projects unsuitable to the service provider, such as those outside of a predetermined radius of the service provider's location, are not shown to the service provider. Additionally, the service provider may use selection criteria to filter the project list on the central resource to best match their personal requirements.

Next, a VIEW PROJECT step 303 follows, wherein the service provider may select a project from the project list to view more data on its project profile. The service provider then reviews the data on the project profile, including the average quote provided by other service providers looking to undertake the project. If they do not wish to undertake this project, the return to the BROWSE PROJECTS step 302 and select another project to view. If they wish to undertake the project, there follows an INITIAL QUOTE step 304.

The INITIAL QUOTE step 304 allows a plurality of service provider to express interest in becoming associated with the project profile by providing bid data in the form of an initial quote to the customer, such as the cost to undertake and complete the project. The service provider may use the project profile data such that they may provide more informed, accurate bid data. The project profile may contain project data in the form of, for example, digital scans, drawings, blueprints, measurements or diagrams. In this way, the service provider may make a better estimate as to the quantity of resources, including materials; labour and time, needed to complete the project, and so can make a more informed bid or quote for the project. Allowing the service provider to view the relevant project profile data before bidding for the project reduces the risk of miscalculations, which in turn reduces waste, overproduction and misallocation of resources. This provides both sustainability and waste reduction benefits.

This bid data is recorded to the central resource, and the customer is allowed to view this bid data such that they may choose which service provider becomes associated with the project. Additionally, the customer may access and view the service provider profile of each service provider created or accessed in the DASHBOARD step 301 of the method 300. In this way, the customer may view data regarding the service provider to better educate their service provider selection. The service provider profile can include verified data regarding the service provide, such that the customer knows the service provider profile contains accurate, reliable data and trust can be built between the customer and the service provider.

The data compiled in the project profile on the central resource allows the service provider to provide more informed, accurate bid data. By allowing a plurality of service providers to submit quotes for the project, quotes that are more competitive are offered and service providers who are not serious about being associated with the project are deterred. Additionally, the customer may select the best fit from the plurality of service providers offering to undertake the project, reducing the risk of project incompletion, potential issues or customer-service provider relation breakdown during the project.

The INITIAL QUOTE step 304 also allows the service provider to view further project specific data on the project profile and any project profile changes made by the customer.

The bid data provided by each service provider may be cross checked with a reference source to ensure that the bid data provided is accurate and not an over or under estimate. For example, the reference source may comprise bid data regarding historic projects completed by the service provider.

Following the INITIAL QUOTE step 304, the customer may select up to three service providers to enter a bidding round in a SHORTLIST step 306. Herein, the most attractive, well-matched service providers are shortlisted by the customer. The SHORTLIST step 306 is beneficial for insurance purposes, and quotes include insurance data, such as required quality and safety checks, at no additional cost to the customer. If the service provider does not make the shortlist, the INITIAL QUOTE step 304 is followed by an UNSUCCESSFUL BID step 305, wherein the service provider is informed they are unsuccessful and this data is recorded to the central resource.

In the INITIAL QUOTE step 304, the customer may instead select a single service provider who wishes to be associated with the project rather than shortlisting a plurality of service providers. If this is the case, a SUCCESSFUL BID step 310 is initiated (arrow B). The SHORTLIST step 306 and proceeding CLARIFICATION 307 and FINAL QUOTE 308 steps are skipped. In this way, the initial bid data and quote provided by the successful service provider in the INITIAL QUOTE step 304 becomes the final quote for the project.

Successful service providers in the SHORTLIST step 306 then proceed to a CLARIFICATION step 307 wherein a dialogue between the service provider and customer is initiated. The service provider and customer can ask questions and provide clarification regarding details of the project, such that all parties have an improved understanding in the project and further project profile data can be recorded to the central resource.

If the service provider wishes to bid on the project, a FINAL QUOTE step 308 is initiated, wherein the service provider provides their final quote, adjusted to reflect their improved understanding of the project requirements. The customer then selects the service provider they wish to undertake the project. Any unsuccessful service providers are informed of their unsuccessful bid in an UNSUCESSFUL BID step 309. The unsuccessful service providers may then return to the BROWSE PROJECTS step 302 to repeat the process on another project.

The successful service provider is selected by the customer and is informed of their success in a SUCCESSFUL BID step 310. Upon customer acceptance of the service provider's final quote in the SUCCESSFUL BID step 310, the service provider and customer have a legal obligation to undertake work on the project and the criteria of a termination clause must be met in the case of early project termination. As such, any termination of the agreement from either party may result in a penalty, or mutual, agreed termination of the project may result in little or no penalty. This reduces risk to either party, for example if the customer decides to terminate the project early or if the service provider ends their association with the project before completion.

The service provider may rescind their interest in being associated with the project or the customer may terminate any agreement with the service provider at any step in the method 300, up to the SUCCESSFUL BID step 310. In this way, there is no legal obligation for both parties to undertake the project together until a final quote for the project has been accepted. Further, service provider interest may be rescinded automatically upon failure to provide data within a predetermined time period, such as 24 hours. This ensures the project is not stalled in the early stages of initiation. This allows a service provider who was not initially selected in the SHORTLIST step 306 to enter the bidding round.

This is followed by a PROJECT UNDERTAKEN step 311, wherein the project is undertaken.

It is envisaged that the PROJECT UNDERTAKEN step 311 may comprise any portion of the embodiments outlined in FIGS. 1, 2 and 4 or any alternative embodiment of the method according to the first aspect of the invention, wherein the service provider is the successful service provider from the SUCCESSFUL BID step 310.

In this way, there is provided a method 300 for accurately monitoring and tracking project posting, quoting, invoicing, scheduling and administration, allowing for the monitoring of overall project progress.

With reference to FIG. 4, there is provided a schematic view of a further embodiment of the computer implemented method according to the first aspect of the present invention. The method 400 may form a portion or the entire PROJECT UNDERTAKEN step 311 of the method 300 of FIG. 3.

First, a FINANCIAL WALLET step 401 is initiated, wherein the customer provides funds for the project which are held in an escrow wallet. In this way, neither party can access or withdraw these funds if doing so would breach the escrow arrangement. Depending on the project, all or a minimum portion of the predicted funds required to complete the project are deposited by the customer. Additionally, a portion of additional funds may be required from the customer to ensure that if the project exceeds the predicted budget, the customer has capacity to absorb these costs.

The escrow wallet increases confidence in both the service provider and the customer, as financial protection is provided in case of dispute, fraud or customer-service provider relationship breakdown. This improves trust between both parties. Additionally, the escrow wallet prevents non-payment from the customer, payment without satisfactory work by the service provider and provides a platform for safe payments to be made. Further, the service provider may be issued with a dedicated payment card wherein funds released to said card may only be used for approved purchases and any funds remaining should there be a budget surplus are held securely until project completion, wherein they are safely returned to the customer. Alternatively, all or a portion of the funds remaining in a budget surplus may be released to the service provider.

Next, a PROJECT COMMENCEMENT step 402 follows, wherein work on the project commences. There follows a PROJECT MANAGEMENT step 403 wherein dedicated project management tools are used to further provide data regarding the project. For example, data regarding Gantt Charts, daily performance targets, onsite arrival and departure times, expenditure receipts and periodic project management review is recorded to the central resource. In this way, progress towards milestones is tracked and monitored with the assistance of dedicated tools and indicators and all data can be viewed by all parties from a single location, the central resource. Additionally, the data can be used to identify areas of improvement or causes of problems if any arise. Data collected by the dedicated project management tools assist in improving both the customer and service provider experience. Automation of accounting, data collection and compiling, reporting, analysing and goal setting may occur with the data recorded to the central resource in the PROJECT MANAGEMENT step 403. In this way, the central resource improves project and resource efficiency.

Next, a MILESTONE COMPLETION step 404 follows, wherein the customer or service provider may record a project milestone as complete; in accordance with the RECORD COMPLETION step 106 of the method 100 of FIG. 1 or the RECORD COMPLETION step 206 of the method 200 of FIG. 2. In order to cross check the completion of project milestone with a reference source, there follows one or more of the following steps: a QC ASSESSMENT step 405, wherein a quality controller assess the milestone completion; a C ASSESSMENT step 406, wherein the customer assess the milestone completion; and or a SP ASSESSMENT step 407, wherein the service provider assess the milestone completion. The assessment undertaken to cross check and verify the project milestone may include some or all of the steps of the CROSS CHECK step 107 of FIG. 1 or the CROSS CHECK step 207 of FIG. 2.

The C ASSESSMENT step 406 and SP ASSESSMENT step 407 allow the customer and service provider to review the milestone work and confirm that it is not only completed, but completed to an acceptable standard. Additionally, a quality controller may visit the project site or externally assess the work completed or the evidence of completed work provided by the customer or service provider. The quality controller validates and audits the project milestone to ensure that the work is completed to a high quality finish and complies with industry standards, regulations and requirements. They may provide their assessment in the QC ASSESSMENT step 405 in the form of a report or certificate, recording this data to the central resource. In particular, a QC ASSESSMENT step 405 may be mandatory dependent on the nature of the project and the project milestone.

There follows an ASSESSMENT COLLATION step 408, wherein data regarding the QC ASSESSMENT step 405, C ASSESSMENT step 406 and or SP ASSESSMENT step 407 and the result of any cross check of milestone completion is collated and recorded to the central resource. The result of the cross check may trigger a QC ASSESSMENT step 405 if appropriate.

Following this, a FINAL DECISION step 409 regarding whether the project milestone has been successfully completed is undertaken utilising the collated data in the ASSESSMENT COLLATION step 408. If the project milestone is successfully completed, the customer and service provider commence work towards the next project milestone and the MILESTONE COMPLETION step 404 is reinitiated when appropriate (arrow C). This may trigger the release of funds provided in the FINANCIAL WALLET step 401 related to completion of that project milestone or the next. If the project milestone is assessed to be incomplete, the customer and service provider resume work towards that project milestone and the MILESTONE COMPLETION step 404 is initiated for a second time when milestone completion is ready to be resubmitted. This prevents progression of the project until all work is completed to a satisfactory standard. It also allows justification for the customer to withhold the release of funds despite the service provider submitting that the milestone is complete.

Alternatively, it is envisaged that steps 405, 406, 407 and 408 are omitted and the cross check of the milestone completion occurs automatically using data recorded on the central resource.

Each FINAL DECISION step 409 acts as an interim step in the project to review the progress of the project. In this way, the project is broken down into distinct stages to allow all parties to monitor and review the project progress. At every FINAL DECISION step 409 either party may choose to cease work on the project, such that the project may be terminated in a PROJECT TERMINATION step 410. This is of benefit to both parties, for example, this allows the customer to terminate the project if they are not pleased with the quality of work provided by the service provider. As project termination may be selected at every milestone, this prevents accumulation of risk and cost to both parties as the project progresses towards completion and allows disputes to be solved at the time which they occur. Additionally, unjustified project termination by either party may be investigated and sanctioned using the data stored on the central resource.

Additionally, during the FINAL DECISION step 409, all parties may agree to amend the present or next project milestone, with this amendment recorded in the central resource. For example, the service provider may extend the timeline to complete the milestone or the customer may increase the milestone budget. In this way, project flexibility is improved and the central resource reflects real time decisions regarding the project.

Once all project milestones associated with the project pathway are assessed to be complete, a PROJECT ANALYSIS step 412 is initiated. Herein the project is recorded as complete and funds from the FINANCIAL WALLET step 401 are released automatically or manually.

Analysis of the project occurs such that accurate data regarding the customer, service provider and completed project is recorded to the central resource for future reference. During the PROJECT ANALYSIS step 412, data from the central resource is inputted in a DATA step 411. Herein, all data regarding the project is collated together and collated with historic data regarding each party, such that the data can be associated with future projects. For example, all work completed on a building is collated and can be viewed when future projects are undertaken on the building, and all project work undertaken by a service provider is collated to assist in accurately influencing the reputation and portfolio of the service provider. This collation of data on the central resource has numerous financial, social and safety benefits and assists in building the trustworthiness of both the customer and the service provider. Additionally, it assists as an educational tool with, for example, employers being able to assess the training and quality of work of an apprentice in the role of the service provider.

1. A computer implemented method for monitoring the initiation, progression and completion of a project, the computer implemented method comprising the method steps of:
allowing a customer to create a project profile;
associating a service provider with the project profile;
providing a project pathway comprising at least one project milestone;
associating the project pathway with the project profile;
recording the project pathway and the project profile on a central resource;
recording the completion of the at least one project milestone on the central resource; and
cross-checking the completion of the at least one project milestone with a reference source.

2. The computer implemented method of claim 1, wherein the step of allowing a customer to create a project profile comprises the steps of:
allowing the customer to provide verifiable project data; and
cross-checking at least one item of verifiable project data against the reference source.

3. The computer implemented method of claim 1 or claim 2, wherein the step of associating a service provider with the project profile comprises the steps of;
allowing a plurality of service providers to express interest in becoming associated with the project profile by providing bid data;
recording the bid data to the central resource;
allowing the customer to view the bid data recorded to the central resource; and
allowing the customer to choose which service provider becomes associated with the project profile.

4. The computer implemented invention of claim 3, wherein the method further comprises cross checking the bid data with the reference source.

5. The computer implemented invention of any one preceding claim, wherein the step of providing a project pathway comprising at least one project milestone comprises retrieving an interim project pathway from the central resource.

6. The computer implemented method of claim 5, wherein the step of providing the project pathway further comprises allowing the customer and or the service provider to adjust the interim project pathway.

7. The computer implemented method of claim 5 or claim 6, wherein the project pathway is agreed by both the customer and the service provider, and the agreement of both the customer and the service provider is recorded to the central resource.

8. The computer implemented method of any one preceding claim, wherein the method comprises prompting the service provider and or the customer to complete the at least one project milestone within the project pathway.

9. The computer implemented method of claim 8, wherein the method further comprises issuing an alert if the at least one project milestone is not completed within at least one predetermined time period.

10. The computer implemented method of claim 9, wherein the at least one predetermined time period is retrieved from the central resource.

11. The computer implemented method of claim 10, wherein the project pathway comprises the at least one predetermined time period.

12. The computer implemented method of any preceding claim, wherein the method further comprises the steps of;
identifying at least one incomplete project milestone within the project pathway; and
communicating the project milestone and its status to at least one of the customer, the service provider and or a third party.

13. The computer implemented method of any one preceding claim comprising the steps of allowing the customer and or the service provider to mark the or the at least one project milestone within the project pathway as complete, and recording the completion of the at least one project milestone in the central resource.

14. The computer implemented method of claim 13, wherein the method further comprises cross checking the completion of the at least one project milestone with the reference source; and
recording data associated with the result of the cross check to the central resource.

15. The computer implemented method of claim 13 or claim 14, wherein the method further comprises recording data associated with the completion of the at least one project milestone to the central resource.

16. The computer implemented method of claim 15, wherein the method further comprises cross checking the data associated with the completion of the at least one project milestone with the reference source; and
recording data associated with the result of the cross check to the central resource.

17. The computer implemented method of any one of claims 13 to 16, comprising the steps of;
retrieving a list of project milestones associated with the project pathway from the central resource;
retrieving a list of competed project milestones from the central resource;
comparing the two lists; and
recording the completion of the project pathway in the central resource if the tasks associated with the project pathway have been completed.

18. The computer implemented method of any one preceding claim, wherein the reference source comprises a third-party database.

19. The computer implemented method of any one preceding claim, wherein the reference source comprises the central resource.

20. The computer implemented method of any one preceding claim, wherein the reference source comprises information provided by the customer, the service provider or a quality controller.

21. The computer implemented method of any one preceding claim, wherein the method further comprises recording the association of the customer, the service provider and the project pathway in the central resource.

22. A data processing apparatus comprising means for carrying out the method of any one preceding claim.

23. A computer program comprising instructions which, when the program is executed by a computer, cause the computer to carry out the method of any one of claims 1 to 21.

24. A computer-readable medium comprising instructions which, when executed by a computer, cause the computer to carry out the method of any one of claims 1 to 21.
